(19) United States
(12) Patent Application Publication
(10) Pub. No.: US 2023/0360158 A1
(43) Pub. Date: Nov. 9, 2023

(54) INTELLIGENT TRANSFER OF ASSETS USING BLOCKCHAIN TECHNOLOGY

(71) Applicant: Bank of America Corporation, Charlotte, NC (US)

(72) Inventors: RAJA ARUMUGAM MAHARAJA, Chennai (IN); Draupa Shrikanth, Chennai (IN)

(21) Appl. No.: 17/740,060

(22) Filed: May 9, 2022

(51) Int. Cl. G06Q 50/18; G06Q 20/38

(52) U.S. Cl. CPC G06Q 50/186; G06Q 20/389

(57) ABSTRACT

A system includes a central computing node coupled to a primary computing node, wherein the central computing node and the primary computing node are part of a blockchain network. The primary computing node comprises a first processor configured to receive information relating to a first plurality of possessions owned by a primary user including information relating to at least one nominee user and record the information in a first block of a private blockchain. The central computing node comprises a second processor configured to receive a notification that the primary user has passed away, extract information relating to first plurality of possessions and the at least one nominee user, identify one or more nominee possessions, map one or more possessions of the primary user to corresponding nominee possessions, and transfer the one or more possessions to the nominee user based on the mapping.

### TECHNICAL FIELD

The present disclosure relates generally to data processing, and more specifically to intelligent transfer of assets using blockchain technology.

### BACKGROUND

A computing infrastructure often receives and stores sensitive data including personal information of users registered to the computing infrastructure. Data files storing a user's personal information may need to be updated from time to time, for example, based on life events relating to the user. These data files may be updated several times over an extended length of time. In some cases, personal data of a user from one or more source data files may need to be transferred to or merged with one or more target data files belonging to one or more target users. There are challenges in present systems relating to securely capturing, updating and storing data in a computing infrastructure. There are additional challenges in present systems relating to identifying a correct target user and a correct target data file of the target user for transferring data or merging of data.

### SUMMARY

The system and methods implemented by the system as disclosed in the present disclosure provide technical solutions to the technical problems discussed above by updating data files automatically and intelligently, recording updates to a data file in a secure manner and by intelligently determining a correct target data file for transferring data from a source data file. The disclosed system and methods provide several practical applications and technical advantages.

For example, the disclosed system and methods provide the practical application of intelligently updating a data file in response to detecting one or more data interactions relating to data stored in the data file. For example, as described in accordance with embodiments of the present disclosure, a central manager extracts a plurality of data points relating to data stored in a data file and detects a data interaction that occurred in a computing infrastructure and is associated with at least one of the extracted data points. The central manager automatically updates the data file to reflect the detected data interaction. Updating a data file automatically and intelligently may help ensure that a most recent version of the data file is maintained at all times. This helps ensure that whenever a data transfer is initiated from a source data file to a target data file, the target data file receives a most recent version of the source data file reflecting all data interactions relating to the source data file.

The disclosed system and methods provide the additional practical application of tracking updates to data files that store personal information of a primary user and personal information of one or more nominee users in a secure and traceable manner. As disclosed in accordance with embodiments of the present disclosure, the disclosed system leverages blockchain technology to record data interactions relating to updating data files that store personal information of a primary user and nominee information relating to one or more nominee users. For example, each data update of a data file is stored in a block of a blockchain. As data interactions performed in a blockchain network are immutable, the disclosed system provides a secure mechanism to store information, avoids unauthorized update activities and helps ensure traceability and accountability in the event of an unauthorized and malicious update activity. By allowing information to be securely stored in a blockchain, the disclosed system improves security of computing system used to store and process data related to transfer of possessions between users.

The disclosed system and methods provide the additional practical application of intelligently identifying a correct target data file to transfer contents of a source data file. As disclosed in accordance with embodiments of the present disclosure the central manager employs a machine learning model to extract a plurality of data points from data stored in a source data file and data stored in a plurality of target data files. The machine learning model compares the data points extracted from the source data file with the data points extracted from the plurality of target data files and intelligently selects a target data file that has at least one common data point with the source data file. The central manager transfers data from the source data file to the selected target data file. By intelligently selecting a target data file for the data transfer, the disclosed system helps ensure that data is not transferred to a wrong target data file. By intelligently selecting an appropriate target data file for a data transfer as described in the present disclosure, the disclosed system and methods avoid the time consuming and cumbersome process relating to determining how the contents from a source data file are to be transferred to a nominee user. This may also generally improve processing efficiency of computing systems that process transfer of data between users.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates a flowchart of an example method for transfer of possessions from a primary user to one or more nominee users, in accordance with one or more embodiments of the present disclosure; and

FIG. 3 illustrates an example schematic diagram of a central computing node shown in FIG. 1, in accordance with one or more aspects of the present disclosure.

### DETAILED DESCRIPTION

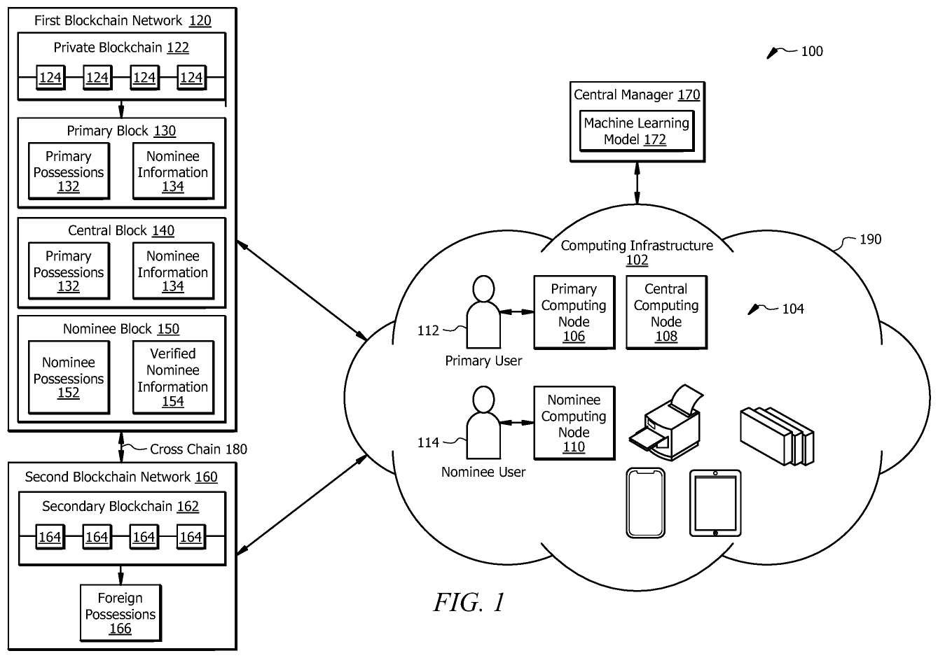

FIG. 1 is a schematic diagram of a system 100, in accordance with certain aspects of the present disclosure. As shown, system 100 includes a computing infrastructure 102 including a plurality of computing nodes 104 connected to a network 190. Computing infrastructure 102 may be representative of an Information Technology (IT) infrastructure of an organization including a plurality of hardware and software components. The hardware components may include, but are not limited to, computing nodes 104 such as desktop computers, smartphones, tablet computers, laptop computers, servers and data centers, and other hardware devices such as printers, routers, hubs, switches, and memory devices all connected to the network 190. Software components may include software applications that are run by one or more of the computing nodes including, but not limited to, operating systems, user interface applications, third party software, database management software, service management software and other customized software programs implementing particular functionalities. For example, software code relating to one or more software applications may be stored in a memory device and one or more processors may process the software code to implement respective functionalities.

As shown in FIG. 1, computing nodes 104 of the computing infrastructure 102 may include a primary computing node 106, a central computing node 108 and a nominee computing node 110. As described in further detail below, the primary computing node 106 may be owned and/or accessible by a primary user 112 of the computing infrastructure 102 and the nominee computing node 110 may be owned and/or accessible by a nominee user 114 of the computing infrastructure 102. Central computing node 108 may belong to an organization or institution that owns and/or manages the computing infrastructure 102. In one embodiment, one or both of the primary computing node 106 and nominee computing node 110 is a standalone computing device (e.g., desktop computer, laptop computer, tablet computer, smartphone etc.) that can be operated by the respective primary user 112 and nominee user 114 and communicate with other devices connected to the network 190. In one embodiment, the central computing node 108 may include one or more servers owned and/or managed by an organization or institution that owns and/or manages the computing infrastructure 102.

Each computing node 104 of the computing infrastructure 102 may be representative of a computing system hosting software applications that may be installed and run locally or may be used to access software applications running on a server (not shown). The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes 104 may be representative of a server running one or more software applications to implement respective functionality as described below. In certain embodiments, one or more of the computing nodes 104 may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

The computing nodes 104 or a portion thereof of the computing infrastructure 102 may be part of one or more blockchain networks. For example, a first set of computing nodes 104 may be part of a first blockchain network 120 and a second set of the computing nodes 104 may be part of a second blockchain network 160. The first and second set of computing nodes 104 may share one or more computing nodes 104, meaning one or more computing nodes 104 may be part of the first blockchain network 120 as well as the second blockchain network 160. In one embodiment, the first set of computing nodes 104 is same as the second set of computing nodes 104, meaning both the first blockchain network 120 and the second blockchain network 160 include the same set of computing nodes 104. The first blockchain network 120 implements a first blockchain (shown as private blockchain 122) across the first set of the computing nodes 104 and the second blockchain network 160 implements a second blockchain (shown as secondary blockchain 162) across the second set of the computing nodes 104. The first blockchain network 120 may be communicatively coupled to the second blockchain network 160 using a cross-chain 180. Cross-chain technology generally allows interoperability between two relatively independent blockchains (e.g., blockchains 122 and 162). In the context of the present disclosure, cross-chain 180 allows data transfer to occur between the first blockchain network 120 and the second blockchain network 160. In one embodiment, one or more of the primary computing node 106, the central computing node 108 and the nominee computing node 110 is part of each of the first blockchain network 120 and the second blockchain network 160.

A blockchain (e.g., blockchains 122 and 162) generally is an open, decentralized and distributed digital ledger consisting of records called blocks that are used to record data interactions across many computing nodes (e.g., computing nodes 104). Each computing node 104 of a blockchain network (e.g., first blockchain network 120 and second blockchain network 160) may maintain a copy of the blockchain ledger. Logically, a blockchain is a chain of blocks which contains specific information. As shown in FIG. 1, private blockchain 122 includes a chain of blocks 124 and blockchain 162 includes a chain of blocks 164. Once recorded, the data in any given block cannot be altered retroactively without alteration of all subsequent blocks, which requires consensus of the network majority. Each computing node within the blockchain network maintains, approves, and updates new entries. The system is controlled not only by separate individuals, but by everyone within the blockchain network. Each member ensures that all records and procedures are in order, which results in data validity and security. Thus, the distributed ledger can record interactions between two parties efficiently and in a verifiable and permanent way. By design, a blockchain is resistant to modification of the data. For use as a distributed ledger, a blockchain is typically managed by a peer-to-peer network collectively adhering to a protocol for inter-node communication and validating new blocks. In the context of the present disclosure, each computing node 104 of the first set of computing nodes 104 may store a copy of a blockchain ledger of the first blockchain network 120, wherein each copy of the blockchain ledger includes a copy of the blockchain 122. Similarly, each computing node 104 of the second set of computing nodes 104 may store a copy of a blockchain ledger of the second blockchain network 160, wherein each copy of the blockchain ledger includes a copy of the blockchain 162.

Each computing node 104 of a blockchain network (e.g., first blockchain network 120 and second blockchain network 160) is configured to process new blocks (e.g., blocks 124 and 164) generated for the blockchain (e.g., blockchain 122 and 162) and maintain a most recent copy of the blockchain in the respective ledgers. Any new interaction or activity within the blockchain network may trigger the building of a new block of the blockchain. An interaction may include a computing node 104 of the blockchain network transmitting or receiving data from another computing node 104 of the blockchain network or from a computing node that is not part of the blockchain network. Before a new block is added to the blockchain, it needs to be verified by a majority of the computing nodes in the blockchain network. For example, once a new block 124 is created at a computing node 104 belonging to the first blockchain network 120, the new block 124 is sent to each other computing node 104 in the first blockchain network 120. Each other computing node 104 verifies the new block 124 and checks whether the information stated in the new block 124 is correct. Once approved by a majority of the computing nodes 104, the new block 124 is added to the blockchain 122. Once a new block 124 is approved for addition to the blockchain 122, each of the computing nodes 104 of the first blockchain network 120 may be configured to update a local copy of the blockchain 122 persisted in the respective ledger to reflect the addition of the new block 124.

Each block of the blockchain (e.g., blockchain 122 and 162) includes a hash of the block, a hash of the previous block, data that records one or more interactions or activities associated with the block, and a timestamp of the one or more interactions or activities recorded by the block. The data stored in each block depends on the type of blockchain. For example, the data included in each block may include information relating to the interaction recorded by the block including transmitting/receiving data, details of the data files, a copy of data received or generated as part of the interaction, identities of the sending and receiving nodes involved in the interaction etc. A hash of a block is like a fingerprint that uniquely identifies the block (and the interaction or activity recorded by the block) within the blockchain. Each hash of a block is generated based on a cryptographic hash algorithm. A blockchain network (e.g., 120 and/or 160) uses public-key cryptography to securely transfer data between computing nodes. Public-key cryptography uses a combination of a public key and private key to secure data in a blockchain network so that only the rightful owner of data can access the data. A public key is like an address on the blockchain to which data may be sent and recorded as belonging to that address. A private key is like a password that gives a user access to digital possessions recorded against a public key.

One or more computing nodes 104 may implement one or more other services or functionalities such as the central manager 170. For example, one or more computing nodes 104 may run a respective software program to implement central manager 170. In one embodiment, the central manager 170 may be implemented by the central computing node 108 of an organization or institution that owns and/or manages the computing infrastructure 102.

Embodiments of the present disclosure describe a system and methods implemented by the system for automatic and intelligent capture of information related to possessions owned by a primary user and nominee information relating to one or more nominee users. As described further, capturing nominee information may include automatically capturing information relating to possessions owned by a nominee user. The system and methods further provide automatic and intelligent transfer of data relating to possessions owned by the primary user to one or more nominee users. For example, as described in further detail below, system 100 may be used to capture information relating to possessions (shown as primary possessions 132) owned by the primary user 112 and information relating to one or more nominees (e.g., nominee information 134 of nominee user 114) including information relating to possessions owned by the nominee user 114 (shown as nominee possessions 152). Information relating to the primary possessions 132, nominee information 134 and nominee possessions 152 may be stored in respective data files of the private blockchain 122 and/or secondary blockchain 162. As described in more detail below, the disclosed system and methods may automatically and intelligently capture updates to the primary possessions 132, nominee information 134 and nominee possessions 152, and automatically update the respective data files to help ensure that most recent information is maintained in the data files relating to the primary possessions 132 of the primary user 112, nominee users 114 and nominee possessions 152, and that data relating to the primary possessions 132 is transferred to the appropriate nominee users 114 as and when needed. System 100 may further be used to transfer data from source data files storing information related to primary possessions 132 owned by the primary user 112 to one or more target data files of one or more nominee users 114 automatically, intelligently and efficiently.

Primary computing node 106 may be configured to receive information from the primary user 112 relating to a plurality of primary possessions 132 owned by the primary user 112. For example, primary computing node 106 may provide a user interface using which the primary user 112 may provide information relating to primary possessions 132 owned by the primary user 112. Primary user 112 may also provide nominee information 134 relating to one or more nominee users 114 including information relating to how the primary possessions 132 are to be distributed to the one or more nominee users 114 after demise of the primary user 112. The user interface may allow the primary user 112 to provide the information relating to the primary possessions 132 and nominee information 134 by entering information in respective data fields, by making selections and/or answering questions. Primary possessions 132 owned by the primary user 112 may include any physical possession or virtual/digital possession (e.g., data files) owned by the primary user 112. Nominee information 134 may include information relating to one or more nominee users 114 including, but not limited to, a spouse, children, parents, siblings or any other nominee person designated by the owner of the possessions. Nominee information 134 may include personal details relating to a nominee user 114 such as full legal name, home address, social security number, driver license number and state identification number. Information relating to how the primary possessions 132 are to be distributed to the one or more nominee users 114 may include which nominee user 114 is to receive what portion (e.g., percentage) of a primary possession 132.

In one or more embodiments, primary user 112 may provide information relating to the primary possessions 132 and nominee information 134 by uploading a soft copy of one or more documents containing this information using the user interface provided at the primary computing node 106. The primary computing node 106 may be configured to extract information relating to the primary possessions 132 and the nominee information 134 from one or more of the uploaded documents.

When primary user 112 provides information relating to the primary possessions 132 and nominee information 134 for the first time, primary computing node 106, or any other computing node (e.g., central computing node 108) of the first blockchain network 120 of which the primary computing node 106 is a part, may generate a primary block 130 (also referred to as genesis block) of the private blockchain 122 and store the information relating to the primary possessions 132 and nominee information 134 as provided by the primary user 112 in respective data files in the primary block 130. The private blockchain 122 may be a permissioned blockchain owned and controlled by the primary user 112 via the primary computing node 106. For example, primary user 112 may hold all rights to the private blockchain 122 and may decide which computing node 104 may join the first blockchain network 120. The primary user 112 may further use the primary computing node 106 to selectively provide rights to each computing node 104 including rights to access information (e.g., stored in data files) from particular blocks 124 of the private blockchain 122, read/extract data stored in certain blocks 124, modifying data stored in certain blocks 124 and generate new blocks 124. For example, primary user 112 may allow the central computing node 108 to read data from the primary block 130 but may not allow the central computing node 108 to modify data files stored in the primary block 130. The central computing node 108 may also have rights to generate new blocks 124 and store data in the newly generated blocks 124. In one embodiment, primary user 112 may allow the nominee computing node 110 to join the first blockchain network 120 but may not allow the nominee user to read or modify any data stored in the private blockchain 122.

In one or more embodiments, the primary computing node 106 may be configured to generate a central block 140 and store a copy of the data files relating to the primary possessions 132 and nominee information 134 in the central block 140. In this case, the primary user 112 may not provide the central computing node 108 rights to access (e.g., read and/or modify) data in the primary block 130. However, primary user 112 may provide rights to the central computing node 108 to access data, read data, store data and modify data in the central block 140. The primary user 112 may modify data stored in the primary block 130 at any time, and any updates made to the data stored in the primary block 130 may be automatically applied to the central block 140. It may be noted that any references in this disclosure to the central manager 170 accessing or extracting data from the primary block 130 may equally apply to the central manager 170 accessing or extracting data form the central block 140 when the central manager 170 does not have rights to access the primary block 130.

As described in further detail below, central manager 170 implemented by the central computing node 108 may be configured to identify updates to primary possessions 132 and nominee information 134, and additionally identify information relating to nominee possessions 152 owned by one or more nominee users 114. Central manager 170 may be configured to automatically update information stored in the respective data files to reflect the identified updates to the primary possessions 132, nominee information 134 and nominee possessions 152. Central manager 170 may further be configured to automatically transfer data relating to primary possessions 132 to one or more nominee users 114 after demise of the primary user 112.

Once the primary block 130 is generated and information relating to the primary possessions 132 and nominee information 134 is stored in the primary block 130, central manager 170 may be configured to detect nominee possessions 152 owned by one or more nominee users 114 who were declared by the primary user 112 as part of nominee information 134. Central manager 170 may be configured to extract data relating to the primary possessions 132 and nominee information 134 from the primary block 130 and identify a plurality of data points based on the extracted information. Central manager 170 may employ a machine learning model 172 to identify the plurality of data points from information relating to the primary possessions 132 and nominee information 134 stored in the primary block 130. The data points may include one or more attributes relating to each primary possession 132 and/or data points identifying a nominee user 114. Attributes relating to a primary possession 132 may include, but are not limited to, a type of the primary possession 132, a unique identifier related to the primary possession, a value of the possession. Data points identifying a nominee user 114 may include, but are not limited to, legal name, social security number and state identification number. Machine learning model 172 may be pre-trained using training data sets in order to identify appropriate data points from data stored in the primary block 130 for use in identifying nominee possessions 152, verifying nominee information 134, identifying updates to primary possessions 132 and identifying foreign possessions 166 as further described below.

Central manager 170 may be configured to search for and identify a plurality of nominee possessions 152 owned by a nominee user 114 in response to detecting data interactions that are associated with one or more data points extracted from the information relating to the primary possessions 132 and nominee information 134. In one or more embodiments, central manager 170 may search for data interactions performed in relation to possessions that may be owned by the nominee user 114 based on data points extracted from nominee information 134 provided by the primary user 112. Possessions owned by a person are often associated to personal data points identifying the person such as legal name, social security number, national identification number etc. Central manager 170 may search for possessions that may be owned by the nominee user 114 based on personal data points associated to the possessions. As a result of the searching, central manager 170 may identify one or more possessions that are associated with at least one personal data point of the nominee user 114. For example, central manager 170 may identify a home that is registered to the name and social security number of the nominee user as provided by the primary user 112. The central manager 170 may have access to several systems and networks that may store information relating to possessions of users. These systems and networks may be internal or external to the institution that manages the central computing node 108. Central manager 170 may be configured to search the information stored in these systems and networks to identify nominee possessions 134 owned by a nominee user 114. Once an possession is identified, the identified possession is designated by the central manager 170 as a nominee possession 152. Central manager 170 may be configured to generate a nominee block 150 that stores information relating to all nominee possessions 152 identified by the central manager 170 immediately (or within a pre-configured time) after the primary block 130 is generated. Central manager 170 may add the nominee block 150 to the private blockchain 122. In one embodiment, central manager 170 may ask the primary user 112 to verify nominee possessions 152 identified for a nominee user 114 before storing information relating to the nominee possessions 152 in the blockchain 122. In one embodiment, central manager 170 may search for data interactions performed (e.g., by the nominee user 114) in relation to possessions that are associated with one or more data points (e.g., nominee name, identify number etc.) extracted from nominee information 134 provided by the primary user 112. For example, the nominee user 114 may have performed a data interaction to register a home in the name of the nominee user 114. In this case the data point is the name of the nominee user 114. Since this data interaction is associated with the name of the nominee user, central manager 170 may identify the registered home as a nominee possession 152.

In one or more embodiments, central manager 170 may be configured to obtain information relating to one or more nominee possessions 152 directly from a nominee user 114 who owns the nominee possessions 152. For example, central manager 170 may determine (based on nominee information 134) that a nominee user 114 is registered with the computing infrastructure 102. Central manager 170 may send out a message to the nominee computing node 110 asking the nominee user 114 to provide information relating to one or more nominee possessions 152 owned by the nominee user 114. Central manager 170 may be configured to store information received from the nominee computing node 110 relating to one or more nominee possessions 152 in the private blockchain 122 (e.g., as part of the nominee block 150).

Central manager 170 may be configured to verify and validate nominee information 134 provided by the primary user 112. As described above, central manager 170 may search for nominee possessions 152 based on data points extracted from information relating to primary possessions 132 and nominee information 134 provided by the primary user 112 and stored in the primary block 132. When central manager 170 identifies one or more nominee possessions 152 that are associated with at least one data point extracted from the information provided by the primary user 112, central manager 170 may be configured to match one or more data points extracted from information provided by the primary user 112 with corresponding data points associated with the identified possessions. When each data point extracted from information provided by the primary user 112 correctly matches with a respective data point associated with one or more identified possessions, central manager 170 may determine that the nominee user 114 declared by the primary user 112 is verified and validated.

Central manager 170 may be configured to detect inconsistencies between one or more data points extracted from information provided by the primary user 112 and corresponding data points associated with an identified nominee possession 152. For example, the social security number of a nominee user 114 provided by the primary user 112 may match with a social security number associated with an identified nominee possession 152. However, a legal name of a nominee user 114 provided by the primary user 112 may not entirely match with a legal name registered against the identified nominee possession 152. Central manager 170 may be configured to send out intelligent notifications to the primary computing node 106 to clarify any inconsistencies relating to information provided by the primary user 112 including information relating to primary possessions 132 and/or nominee information 134. Central manager 170 may be configured to include intelligent questions in the notification based on the nature of the identified inconsistency, so that the inconsistency may be appropriately clarified by the primary user 112. Following the above example, central manager 170 may send out a notification to the primary computing node 106 asking the primary user 112 to confirm the full legal name of the nominee user 114 and also provide any alternative names that may have been used for the nominee user 114. Once the nominee information 134 has been verified and/or confirmed by the primary user 112 (e.g., in response to detected inconsistencies), verified nominee information 154 may be stored in the nominee block 150. In one embodiment, machine learning model 172 of the central manager 170 may be pre-trained to generate intelligent questions based on detecting known inconsistencies between one or more data points extracted from information provided by the primary user 112 and corresponding data points associated with an identified nominee possession 152.

After information relating to nominee possessions 152 and verified nominee information 154 is collected and stored in the nominee block 150, central manager 170 may be configured to update this information automatically and intelligently from time to time. For example, central manager 170 may periodically or according to a preconfigured schedule check for changes in nominee information associated with nominee possessions 152 previously identified and stored in private blockchain 122. Central manager 170 may automatically send out intelligent notifications to the primary user 112 asking to update nominee information 134 in response to detecting changes in nominee information associated with a nominee possession 152. For example, central manager 170 may detect that a possession owned by the nominee user 114 has a new associated nominee. In response, central manager 170 may send out a notification to the primary computing node 106 asking the primary user 112 whether nominee information 134 associated with one or more primary possessions 132 is to be updated. Upon receiving updated nominee information 134 from the primary computing node 106 (provided by primary user 112), central manager 170 may update data files relating to the verified nominee information 154 stored in the nominee block 150. In one embodiment, central manager 170 may generate a new nominee block that stores the updated nominee information 154 and adds the new nominee block to private blockchain 122.

Similarly, central manager 170 may periodically or according to a preconfigured schedule check whether a nominee user 114 has acquired new possessions or abandoned any one or more of the existing nominee possessions 152 as previously stored in the nominee block 150. Upon detecting that the nominee user 114 has acquired a new possession, central manager 170 may update data files relating to the nominee possessions 152 stored in the nominee block 150 to add information relating to the newly identified nominee possession 152. Central manager 170 may identify a newly acquired nominee possession 152 by detecting a newly identified possession that is associated with one or more data points extracted from verified nominee information 154. Similarly, upon detecting that the nominee user 114 has abandoned a previously identified nominee possession 152, central manager 170 may update the data files relating to the nominee possessions 152 to delete information relating to the abandoned nominee possession 152. Central manager 170 may detect that a nominee possession 152 has been abandoned when the abandoned nominee possession cannot be detected or the abandoned nominee possession is no more associated with at least one data point extracted from verified nominee information 154. In one embodiment, central manager 170 may generate anew nominee block that stores the updated nominee possessions 152 and adds the new nominee block to private blockchain 122.

Additionally or alternatively, central manager 170 may be configured to update data files relating to primary possessions 132 from time to time after the primary user 112 initially declares the primary possessions 132. For example, central manager 170 may periodically or according to a preconfigured schedule check whether a primary user 112 has acquired new possessions or abandoned any one or more of the existing primary possessions 132 based on information previously stored in the primary block 130. Upon detecting that the primary user 112 has acquired a new primary possession 132, central manager 170 may update data files relating to the primary possessions 132 to add information relating to the newly identified primary possession 132. Central manager 170 may identify a newly acquired primary possession 132 by detecting a newly identified possession that is associated with information of the primary user 112 (e.g. name, social security number etc.). In one embodiment, central manager 170 may detect a data interaction performed (e.g., by the primary user 112) in relation to a new possession that is associated with at least one data point (e.g., name, social security number etc.) extracted from personal information of the primary user 112. For example, central manager 170 may detect that a home has been newly registered against the legal name and social security number of the primary user 112. In one embodiment, the primary user 112 may be registered with the institution that owns the computing infrastructure 102 and thus central manager 170 may have access to personal information of the primary user 112 such as legal name, social security number, national identity number and other identifying information of the primary user 112. Similarly, upon detecting that the primary user 112 has abandoned a previously identified primary possession 132 (e.g., based on detecting a data interaction abandoning the primary possession 132), central manager 170 may update data files relating to the primary possessions 132 to delete information relating to the abandoned primary possession 132. Central manager 170 may detect that a primary possession 132 has been abandoned when the abandoned primary possession 132 cannot be detected in the computing infrastructure 102, the abandoned primary possession is no more associated with personal information of the primary user 112 and/or in response to detecting a data interaction abandoning the primary possession 132. In one embodiment, central manager 170 may generate a new block 124 that stores the updated data files relating to the primary possessions 132 and adds the new block to private blockchain 122. In one embodiment, in response to detecting a new primary possession 132 or an abandoned primary possession 132, central manager 170 may send out a notification to the primary computing node 106 asking the primary user 112 to confirm the new or abandoned primary possession 132. Upon receiving updated information relating to the primary possessions 132 from the primary computing node 106 (e.g., provided by primary user 112), central manager 170 may update the data files relating to the primary possessions 132 as described above and store the updated primary possessions 132 in the private blockchain 122. In one or more additional embodiments, when information relating to a new primary possession 132 is added to the private blockchain 122, central manager 170 may be configured to send out a notification to the primary computing node 106 asking the primary user 112 to designate one or more nominee users 114 in relation to the newly added primary possession 132 and provide information regarding how the newly added primary possession 132 is to be distributed to the one or more designated nominee users 114. Upon receiving the requested information, central manager 170 may update the data files relating to nominee information 154 by adding information relating to the one or more nominee users 114 in relation to the newly added primary possession 132. In one embodiment, central manager 170 may generate a new nominee block that stores the updated data files relating to nominee information 154 and adds the new nominee block to private blockchain 122.

Central manager 170 may be configured to identify data interactions relating to one or more foreign possessions 166 performed in a foreign region away from a home region. For example, the primary user 112 may maintain a permanent place of residence in a home country and most of the primary possessions 132 owned by the primary user 112 may be located in the home country. However, the primary user 112 may own one or more foreign possessions 166 in a foreign country. Central manager 170 may be configured to detect data interactions made by the primary user 112 in a foreign location away from the home location, and identify data interactions made at the foreign location that are associated with a foreign possession 166 owned by the primary user 112 at the foreign location. For example, central manager 170 may detect that the primary user 112 has acquired a new home in a foreign country based on detecting one or more data interactions performed by the primary user 112 in the foreign country including, but not limited to, registering the home against the name and/or social security number of the primary user 112, the foreign home declared in filings to an institution and a wire transfer to a realtor, builder or title company in the foreign country. In response to detecting that the primary user 112 has acquired a new foreign possession 166 in a foreign location, central manager 170 may send out a notification to the primary computing node 106 asking the primary user 112 to confirm the new foreign possession 166. Upon receiving confirmation of the new foreign possession 166 from the primary computing node 106 (e.g., provided by primary user 112), central manager 170 may store information relating to the foreign possession 166 in the secondary blockchain 162. For example, central manager 170 may generate a new block 164 of the secondary blockchain 162 that stores information relating to the newly acquired foreign possession 166 and adds the new block 164 to the secondary blockchain 162. In one or more embodiments, the secondary blockchain 162 stores information relating to all foreign possessions 166 owned by the primary user 112 including any updates to the foreign possessions 166 (e.g. acquiring new foreign possessions or abandoning existing foreign possessions) and data interactions performed by the primary user 112 relating to the foreign possessions 166. In one embodiment, the primary user 112 may explicitly declare a foreign possession 166 using the primary computing node 106, for example, by entering details of the foreign possession in respective fields of a user interface or by uploading a document including information relating to the foreign possession 166. Central manager 170 may be configured to obtain the information relating to each foreign possession 166 provided by the primary user 112 and store the information in the secondary blockchain 162.

In one or more additional embodiments, when information relating to a new foreign possession 166 is added to secondary blockchain 160, central manager 170 may be configured to send out a notification to the primary computing node 106 asking the primary user 112 to designate one or more nominee users 114 in relation to the newly added foreign possession 166 and provide information regarding how the newly added foreign possession 166 is to be distributed to the one or more designated nominee users 114. Upon receiving the requested information, central manager 170 may update data files relating to the nominee information 154 by adding information relating to the one or more nominee users 114 in relation to the newly added foreign possession 166. In one embodiment, central manager 170 may generate a new nominee block that stores the updated data files relating to the nominee information 154 and adds the new nominee block to private blockchain 122.

Central manager 170 may be configured to transfer data from one or more source data files storing information relating to the primary possessions 132 and foreign possessions 166 to one or more target data files of nominee users 114 automatically and intelligently after demise of the primary user 112. Central manager 170 may be configured to receive a notification when the primary user 112 dies. For example, central manager 170 may be configured to receive a copy of a death certificate (e.g., from a concerned authority) verifying that the primary user 112 has passed away. In response to receiving the notification that the primary user 112 has passed away, central manager 170 may be configured to extract information relating to the primary possessions 132 from respective data files stored in the primary block 130 and/or extract updated information relating to the primary possessions 132 stored in one or more other blocks 124 of the private blockchain 122. Central manager 170 may also be configured to extract information relating to foreign possessions 166 from respective data files stored in one or more blocks 164 of the secondary blockchain 162. Central manager 170 may also be configured to extract verified nominee information 154 from respective data files stored in the nominee block 150 and/or updated nominee information 154 from respective data files stored in one or more other blocks 124 of the private blockchain 122. In one embodiment, nominee information 154 may include information relating to how each primary possession 132 is to be distributed to one or more nominee users 114. Central manger 170 may further be configured to extract information relating to nominee possessions 152 from respective data files stored in the nominee block 150 and/or updated information relating to the nominee possessions 152 from respective data files stored in one or more other blocks 124 of the private blockchain 122. In one embodiment, central manager 170 may be configured to extract information relating to one or more of the primary possessions 132, nominee information 134, nominee possessions 152 and foreign possessions 166 from a soft copy of a document uploaded by the primary user 112 and stored in the primary blockchain 122.

Central manager 170 employs the machine learning model 172 to extract a plurality of data points from data relating to primary possessions 132 and foreign possessions 166 stored in source data files (e.g., in primary blockchain 122 and secondary blockchain 160 respectively), and to further extract a plurality of data points from data relating to nominee possessions 152 stored in a plurality of target data files of primary blockchain 122. The machine learning model compares the data points extracted from the source data files with the data points extracted from the target data files. For each source data file containing data relating to a primary possession 132 or a foreign possession 166, machine learning model 172 intelligently selects a target data file that has at least one common data point with the source data file. The central manager 170 transfers data from the source data file to the selected target data file.

For example, machine learning model 172 may be configured to map data relating to one or more primary possessions 132 and foreign possessions 166 to data relating to corresponding nominee possessions 152 based on common data points between the primary possessions 132 and nominee possessions 152. Based on the information stored in the private blockchain 122 and the secondary blockchain 160 the machine learning model 172 may segregate the primary possessions 132, foreign possessions 166 and nominee possessions 152 based on the type of each possession. Machine learning model 172 may intelligently extract data points from information relating to the primary possessions 132/foreign possessions 166 and information relating to the nominee possessions 152. Data points relating to each primary possession 132/or foreign possession 166 may include one or more attributes relating to the primary possession 132 or foreign possession 166 such as a type of the primary possession 132/foreign possession, a unique identifier related to the primary possession 132/foreign possession 166 (e.g., account number), a value of the primary possession 132/foreign possession etc. Similarly, data points relating to each nominee possession 152 may include one or more attributes relating to the nominee possession 152 such as a type of the primary possession 132, a unique identifier related to the nominee possession 152, a value of the nominee possession 152 etc. Machine learning model 172 may compare data points relating to the primary possessions 132 and foreign possessions 166 with the data points relating to the nominee possessions 152. Central manager 170 may map a primary possession 132 or foreign possession 166 to a nominee possession 152 when both possessions are associated with at least one common data point. For example, a primary possession 132 and a nominee possession 152 may be of the same type.

Once one or more primary possessions 132 and/or foreign possessions 166 have been mapped to corresponding one or more nominee possessions 152, central manager 170 may be configured to transfer data from a source data file relating to a primary possession 132 or a foreign possession 166 to a target data file of the nominee user 114 containing data relating to a nominee possession 152 mapped to the primary possession or foreign possession.

In one embodiment, central manager 170 may be configured to freeze the primary block 130 after verifying that the primary user 112 has passed away, so that no more changes may be made to the data stored in the primary block 130.

In one or more embodiments, central manager 170 may be configured to verify the identity of each nominee user 114 before processing a transfer of possessions to the nominee user 114. the machine learning model 172 may be configured to generate intelligent questions based on verified nominee information 154 and/or data relating to nominee possessions 152 stored in private blockchain 122. Central manager 170 may send out a message to the nominee computing node 110 of the nominee user 114 including the intelligent questions. Central manger 170 may verify the identity of a nominee user 114 based on answers to the intelligent questions received from the nominee computing node 110. The intelligent questions are framed such that only the nominee user 114 or a person authorized by the nominee user 114 can know the answers to those questions. For example, based on nominee information 154 of a nominee user 114, central manager 170 may frame a question that asks personal details of the nominee user 114 including a social security number, driver license number etc. Further, based on information relating to a home owned by a nominee user 114, central manager 170 may frame a question that asks a home address of the home. Central manager 170 may be configured to send out several questions to the nominee computing node 110 and may determine that the identity of the nominee user is successfully verified when at least a pre-configured amount of correct answers are received. Central manager 170 may be configured to initiate transfer of data from data files relating to primary possessions 132 and/or foreign possessions 166 after successfully verifying identity of the nominee user 114.

In one example use case, system 100 and methods implemented by the system 100 may be used to transfer possessions from a primary user to one or more nominee users after demise of the primary owner. When a person dies, possessions owned by the person must be properly transferred to one or more nominees designated by the person based on the wishes of the person regarding the distribution of the possessions. Possessions owned by the person may include, but are not limited to, bank accounts, properties, safe deposit boxes, investment accounts, loan accounts (e.g., mortgage accounts), retirement accounts, credit card accounts, and other prized possessions including cars, artwork and jewelry. Nominees may include, but are not limited to, a spouse, children, parents, siblings, relatives or any other nominee person designated by the owner of the possessions. Generally, an owner of a possession provides one or more nominees for the possession when the possession is initially created and/or registered. For example, a person may designate one or more nominees when creating a bank account or registering a property. Additionally or alternatively, the person may prepare a “will” which is a legal document that spells out wishes of the person regarding distribution of possessions owned by the person. The will typically lists out a number of possessions owned by the person, designates one or more nominees, and specifies how the possessions are to be distributed among the nominees after the person's demise. However, possession information and/or nominee information provided at the time of possession creation/registration or will preparation is generally not updated as needed, for example, based on life events. For example, new possessions may be created or existing possessions may be modified, transferred or cease to exist. Further, a person may get married, divorced, have children, move to a different country, change jobs etc. Possession information and nominee information including information on how the possessions are to be distributed may need updating from time to time based on each of these events. Not updating information relating to possessions and nominees as needed may lead to improper distribution of the possessions including one or more possessions being transferred to an undesired person. Presently, no system or method exists that can automatically and intelligently update information related to possessions and nominees. Further, transfer of possessions to designated nominees after a person's demise is a lengthy and cumbersome process. For example a lot of paperwork, approvals and validations may be needed from several concerned authorities to carry out the transfer of possessions after a person's demise. The person may own several possessions that may not have been disclosed via regular channels and thus information relating to such possessions may not have been captured properly, leading to further complications in the transfer of the possessions. Further, presently no system or method exists to capture information relating to possessions created and owned outside a home location (e.g., a foreign country) unless explicitly declared by the owner of the foreign possessions.

In this context, central computing node 108 may be owned and/or operated by a bank and the primary user 112 (and in some cases the nominee user 114) may be registered with the bank. Primary possessions 132 owned by the primary user 112 may include, but are not limited to, bank accounts, properties, safe deposit boxes, investment accounts, loan accounts (e.g., mortgage accounts), retirement accounts, credit card accounts, and other prized possessions including cars, artwork and jewelry. The nominee possessions 152 owned by a nominee user 114 may include, but are not limited to, bank accounts, properties, safe deposit boxes, investment accounts, loan accounts (e.g., mortgage accounts), retirement accounts, credit card accounts, and other prized possessions including cars, artwork and jewelry. As described above, the primary user 112 may provide information relating to the primary possessions 132, foreign possessions 166 and nominee information 134 by uploading soft copies of one or more documents containing the information. The one or more documents may include but are not limited to, a will, a property deed, a mortgage contract, a loan contract, bank statements and picture. In one example, mapping a primary possession 132 to a nominee possession 152 may include mapping a bank account of the primary user 112 to a bank account of the nominee user 114 in response to detecting that both these possessions are of the same type (e.g. bank accounts). Similarly, a loan account of the primary user 112 with one institution may be mapped to a loan account of the nominee user 114 in response to detecting that both possessions are of the same type (e.g., loan accounts) and both possessions are registered with the same institution. When a bank account of the primary user 112 is mapped to a bank account of the nominee user 114, funds from the bank account of the primary user 112 may be transferred to the corresponding bank account of the nominee user 114. In another example, when a loan account of the primary user 112 is mapped to a loan account of the nominee user 114, a balance of the loan from the loan account of the primary user 112 may be transferred to or merged with the loan account of the nominee user 114. In another example, when a primary retirement account of the primary user 112 is mapped to a secondary retirement account of the nominee user 114, funds from the primary retirement account may be transferred to the secondary retirement account.

In one or more embodiments, when a nominee user 114 declared by the primary user 112 does not have access (e.g., possess login credential) to the first blockchain network 120, central manager 170 may generate a separate nominee blockchain (not shown) and provide access of the nominee blockchain to the nominee user 114. Central manager 170 may send out an alert/message to the primary user 112 that the nominee user 114 does not have access to the first blockchain network 120 and that a nominee blockchain has been created for the nominee. Once the nominee blockchain is created, nominee user 114 may access the nominee blockchain using access credentials provided by the central manager 170.

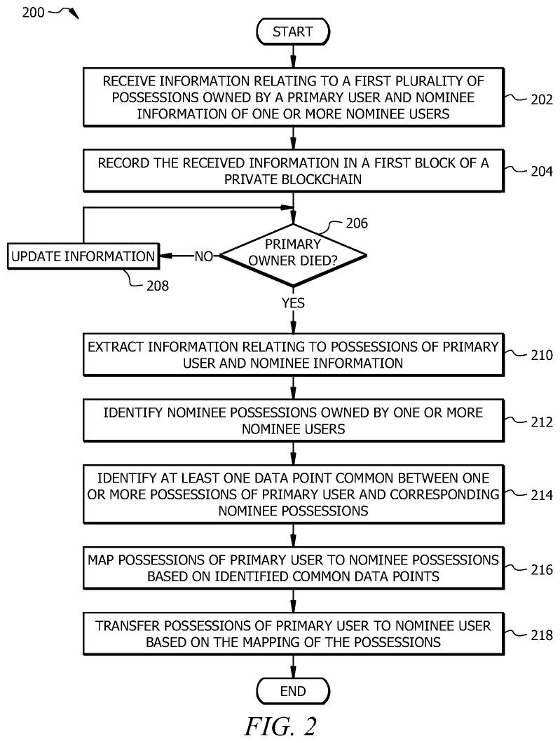

FIG. 2 illustrates a flowchart of an example method 200 for transfer of possessions from a primary user to one or more nominee users, in accordance with one or more embodiments of the present disclosure. Method 200 may be performed by system 100 or a portion thereof.

At operation 202 a primary computing node 106 receives information relating to a first plurality of possessions (e.g., primary possessions 132 and/or foreign possessions 166) owned by a primary user 112. The primary computing node 106 may additionally receive information relating to one or more nominee users 114 that are to receive at least a portion of the primary possessions 132 and/or foreign possessions 166 after demise of the primary user 112.

As described above, primary computing node 106 may be configured to receive information from the primary user 112 relating to a plurality of primary possessions 132 (including foreign possessions 166) owned by the primary user 112. For example, primary computing node 106 may provide a user interface using which the primary user 112 may provide information relating to primary possessions 132 owned by the primary user 112. Primary user 112 may also provide nominee information 134 relating to one or more nominee users 114 including information relating to how the primary possessions 132 are to be distributed to the one or more nominee users 114 after demise of the primary user 112. The user interface may allow the primary user 112 to provide the information relating to the primary possessions 132 and nominee information 134 by entering information in respective data fields, by making selections and/or answering questions. Primary possessions 132 owned by the primary user 112 may include any physical possession or virtual/digital possession (e.g., data files) owned by the primary user 112. Nominee information 134 may include information relating to one or more nominee users 114 including, but not limited to, a spouse, children, parents, siblings or any other nominee person designated by the owner of the possessions. Nominee information 134 may include personal details relating to a nominee user 114 such as full legal name, home address, social security number, driver license number and state identification number. Information relating to how the primary possessions 132 are to be distributed to the one or more nominee users 114 may include which nominee user 114 is to receive what portion (e.g., percentage) of a primary possession 132.

In one or more embodiments, primary user 112 may provide information relating to the primary possessions 132 and nominee information 134 by uploading a soft copy of one or more documents containing this information using the user interface provided at the primary computing node 106. The primary computing node 106 may be configured to extract information relating to the primary possessions 132 and the nominee information 134 from one or more of the uploaded documents.

At operation 204, the primary computing node 106 records the received information in a first block (e.g., primary block 130) of a private blockchain 122 implemented by a blockchain network (e.g., first blockchain network 120).

When primary user 112 provides information relating to the primary possessions 132 and nominee information 134 for the first time, primary computing node 106, or any other computing node (e.g., central computing node 108) of the first blockchain network 120 of which the primary computing node 106 is a part, may generate a primary block 130 (also referred to as genesis block) of the private blockchain 122 and store the information relating to the primary possessions 132 and nominee information 134 as provided by the primary user 112 in respective data files in the primary block 130. The private blockchain 122 may be a permissioned blockchain owned and controlled by the primary user 112 via the primary computing node 106. For example, primary user 112 may hold all rights to the private blockchain 122 and may decide which computing node 104 may join the first blockchain network 120. The primary user 112 may further use the primary computing node 106 to selectively provide rights to each computing node 104 including rights to access information (e.g., stored in data files) from particular blocks 124 of the private blockchain 122, read/extract data stored in certain blocks 124, modifying data stored in certain blocks 124 and generate new blocks 124. For example, primary user 112 may allow the central computing node 108 to read data from the primary block 130 but may not allow the central computing node 108 to modify data files stored in the primary block 130. The central computing node 108 may also have rights to generate new blocks 124 and store data in the newly generated blocks 124. In one embodiment, primary user 112 may allow the nominee computing node 110 to join the first blockchain network 120 but may not allow the nominee user to read or modify any data stored in the private blockchain 122.

Once the primary block 130 is generated and information relating to the primary possessions 132 and nominee information 134 is stored in the primary block 130, central manager 170 may be configured to detect nominee possessions 152 owned by one or more nominee users 114 who were declared by the primary user 112 as part of nominee information 134. Central manager 170 may be configured to extract data relating to the primary possessions 132 and nominee information 134 from the primary block 130 and identify a plurality of data points based on the extracted information. Central manager 170 may employ a machine learning model 172 to identify the plurality of data points from information relating to the primary possessions 132 and nominee information 134 stored in the primary block 130. The data points may include one or more attributes relating to each primary possession 132 and/or data points identifying a nominee user 114. Attributes relating to a primary possession 132 may include, but are not limited to, a type of the primary possession 132, a unique identifier related to the primary possession (e.g., data file number), a value of the possession (e.g.,). Data points identifying a nominee user 114 may include, but are not limited to, legal name, social security number and state identification number. Machine learning model 172 may be pre-trained using training data sets in order to identify appropriate data points from data stored in the primary block 130 for use in identifying nominee possessions 152, verifying nominee information 134, identifying updates to primary possessions 132 and identifying foreign possessions 166 as further described below.

Central manager 170 may be configured to search for and identify a plurality of nominee possessions 152 owned by a nominee user 114 in response to detecting data interactions that are associated with one or more data points extracted from the information relating to the primary possessions 132 and nominee information 134. In one or more embodiments, central manager 170 may search for data interactions performed in relation to possessions that may be owned by the nominee user 114 based on data points extracted from nominee information 134 provided by the primary user 112. Possessions owned by a person are often associated to personal data points identifying the person such as legal name, social security number, national identification number etc. Central manager 170 may search for possessions that may be owned by the nominee user 114 based on personal data points associated to the possessions. As a result of the searching, central manager 170 may identify one or more possessions that are associated with at least one personal data point of the nominee user 114. For example, central manager 170 may identify a home that is registered to the name and social security number of the nominee user as provided by the primary user 112. The central manager 170 may have access to several systems and networks that may store information relating to possessions of users. These systems and networks may be internal or external to the institution that manages the central computing node 108. Central manager 170 may be configured to search the information stored in these systems and networks to identify nominee possessions 134 owned by a nominee user 114. Once an possession is identified, the identified possession is designated by the central manager 170 as a nominee possession 152. Central manager 170 may be configured to generate a nominee block 150 that stores information relating to all nominee possessions 152 identified by the central manager 170 immediately (or within a pre-configured time) after the primary block 130 is generated. Central manager 170 may add the nominee block 150 to the private blockchain 122. In one embodiment, central manager 170 may ask the primary user 112 to verify nominee possessions 152 identified for a nominee user 114 before storing information relating to the nominee possessions 152 in the blockchain 122. In one embodiment, central manager 170 may search for data interactions performed (e.g., by the nominee user 114) in relation to possessions that are associated with one or more data points (e.g., nominee name, identify number etc.) extracted from nominee information 134 provided by the primary user 112. For example, the nominee user 114 may have performed a data interaction to register a home in the name of the nominee user 114. In this case the data point is the name of the nominee user 114. Since this data interaction is associated with the name of the nominee user, central manager 170 may identify the registered home as a nominee possession 152.

In one or more embodiments, central manager 170 may be configured to obtain information relating to one or more nominee possessions 152 directly from a nominee user 114 who owns the nominee possessions 152. For example, central manager 170 may determine (based on nominee information 134) that a nominee user 114 is registered with the computing infrastructure 102. Central manager 170 may send out a message to the nominee computing node 110 asking the nominee user 114 to provide information relating to one or more nominee possessions 152 owned by the nominee user 114. Central manager 170 may be configured to store information received form the nominee computing node 110 relating to one or more nominee possessions 152 in the private blockchain 122 (e.g., as part of the nominee block 150).

Central manager 170 may be configured to verify and validate nominee information 134 provided by the primary user 112. As described above, central manager 170 may search for nominee possessions 152 based on data points extracted from information relating to primary possessions 132 and nominee information 134 provided by the primary user 112 and stored in the primary block 132. When central manager 170 identifies one or more nominee possessions 152 that are associated with at least one data point extracted from the information provided by the primary user 112, central manager 170 may be configured to match one or more data points extracted from information provided by the primary user 112 with corresponding data points associated with the identified possessions. When each data point extracted from information provided by the primary user 112 correctly matches with a respective data point associated with one or more identified possessions, central manager 170 may determine that the nominee user 114 declared by the primary user 112 is verified and validated.

Central manager 170 may be configured to detect inconsistencies between one or more data points extracted from information provided by the primary user 112 and corresponding data points associated with an identified nominee possession 152. For example, the social security number of a nominee user 114 provided by the primary user 112 may match with a social security number associated with an identified nominee possession 152. However, a legal name of a nominee user 114 provided by the primary user 112 may not entirely match with a legal name registered against the identified nominee possession 152. Central manager 170 may be configured to send out intelligent notifications to the primary computing node 106 to clarify any inconsistencies relating to information provided by the primary user 112 including information relating to primary possessions 132 and/or nominee information 134. Central manager 170 may be configured to include intelligent questions in the notification based on the nature of the identified inconsistency, so that the inconsistency may be appropriately clarified by the primary user 112. Following the above example, central manager 170 may send out a notification to the primary computing node 106 asking the primary user 112 to confirm the full legal name of the nominee user 114 and also provide any alternative names that may have been used for the nominee user 114. Once the nominee information 134 has been verified and/or confirmed by the primary user 112 (e.g., in response to detected inconsistencies), verified nominee information 154 may be stored in the nominee block 150. In one embodiment, machine learning model 172 of the central manager 170 may be pre-trained to generate intelligent questions based on detecting known inconsistencies between one or more data points extracted from information provided by the primary user 112 and corresponding data points associated with an identified nominee possession 152.

After information relating to nominee possessions 152 and verified nominee information 154 is collected and stored in the nominee block 150, central manager 170 may be configured to update this information automatically and intelligently from time to time. For example, central manager 170 may periodically or according to a preconfigured schedule check for changes in nominee information associated with nominee possessions 152 previously identified and stored in private blockchain 122. Central manager 170 may automatically send out intelligent notifications to the primary user 112 asking to update nominee information 134 in response to detecting changes in nominee information associated with a nominee possession 152. For example, central manager 170 may detect that a possession owned by the nominee user 114 has a new associated nominee. In response, central manager 170 may send out a notification to the primary computing node 106 asking the primary user 112 whether nominee information 134 associated with one or more primary possessions 132 is to be updated. Upon receiving updated nominee information 134 from the primary computing node 106 (provided by primary user 112), central manager 170 may update data files related to the verified nominee information 154 stored in the nominee block 150. In one embodiment, central manager 170 may generate a new nominee block that stores the updated nominee information 154 and adds the new nominee block to private blockchain 122.

Similarly, central manager 170 may periodically or according to a preconfigured schedule check whether a nominee user 114 has acquired new possessions or abandoned any one or more of the existing nominee possessions 152 as previously stored in the nominee block 150. Upon detecting that the nominee user 114 has acquired a new possession, central manager 170 may update data files related to the nominee possessions 152 stored in the nominee block 150 to add information relating to the newly identified nominee possession 152. Central manager 170 may identify a newly acquired nominee possession 152 by detecting a newly identified possession that is associated with one or more data points extracted from verified nominee information 154. Similarly, upon detecting that the nominee user 114 has abandoned a previously identified nominee possession 152, central manager 170 may update data files related to the nominee possessions 152 to delete information relating to the abandoned nominee possession 152. Central manager 170 may detect that a nominee possession 152 has been abandoned when the abandoned nominee possession cannot be detected or the abandoned nominee possession is no more associated with at least one data point extracted from verified nominee information 154. In one embodiment, central manager 170 may generate a new nominee block that stores the updated nominee possessions 152 and adds the new nominee block to private blockchain 122.

Additionally or alternatively, central manager 170 may be configured to update data files relating to primary possessions 132 from time to time after the primary user 112 initially declares the primary possessions 132. For example, central manager 170 may periodically or according to a preconfigured schedule check whether a primary user 112 has acquired new possessions or abandoned any one or more of the existing primary possessions 132 based on information previously stored in the primary block 130. Upon detecting that the primary user 112 has acquired a new primary possession 132, central manager 170 may update data files related to the primary possessions 132 to add information relating to the newly identified primary possession 132. Central manager 170 may identify a newly acquired primary possession 132 by detecting a newly identified possession that is associated with information of the primary user 112 (e.g. name, social security number etc.). In one embodiment, central manager 170 may detect a data interaction performed (e.g., by the primary user 112) in relation to a new possession that is associated with at least one data point (e.g., name, social security number etc.) extracted from personal information of the primary user 112. For example, central manager 170 may detect that a home has been newly registered against the legal name and social security number of the primary user 112. In one embodiment, the primary user 112 may be registered with the institution that owns the computing infrastructure 102 and thus central manager 170 may have access to personal information of the primary user 112 such as legal name, social security number, national identity number and other identifying information of the primary user 112. Similarly, upon detecting that the primary user 112 has abandoned a previously identified primary possession 132 (e.g., based on detecting a data interaction abandoning the primary possession 132), central manager 170 may update data files related to the primary possessions 132 to delete information relating to the abandoned primary possession 132. Central manager 170 may detect that a primary possession 132 has been abandoned when the abandoned primary possession 132 cannot be detected in the computing infrastructure 102, the abandoned primary possession is no more associated with personal information of the primary user 112 and/or in response to detecting a data interaction abandoning the primary possession 132. In one embodiment, central manager 170 may generate a new block 124 that stores the updated data files related to primary possessions 132 and adds the new block to private blockchain 122. In one embodiment, in response to detecting a new primary possession 132 or an abandoned primary possession 132, central manager 170 may send out a notification to the primary computing node 106 asking the primary user 112 to confirm the new or abandoned primary possession 132. Upon receiving updated information relating to the primary possessions 132 from the primary computing node 106 (e.g., provided by primary user 112), central manager 170 may update data files related to the primary possessions 132 as described above and store the updated primary possessions 132 in the private blockchain 122. In one or more additional embodiments, when information relating to a new primary possession 132 is added to the private blockchain 122, central manager 170 may be configured to send out a notification to the primary computing node 106 asking the primary user 112 to designate one or more nominee users 114 in relation to the newly added primary possession 132 and provide information regarding how the newly added primary possession 132 is to be distributed to the one or more designated nominee users 114. Upon receiving the requested information, central manager 170 may update data files related to the nominee information 154 by adding information relating to the one or more nominee users 114 in relation to the newly added primary possession 132. In one embodiment, central manager 170 may generate anew nominee block that stores the updated data files related to nominee information 154 and adds the new nominee block to private blockchain 122.

Central manager 170 may be configured to identify data interactions relating to one or more foreign possessions 166 performed in a foreign region away from a home region. For example, the primary user 112 may maintain a permanent place of residence in a home country and most of the primary possessions 132 owned by the primary user 112 may be located in the home country. However, the primary user 112 may own one or more foreign possessions 166 in a foreign country. Central manager 170 may be configured to detect data interactions made by the primary user 112 in a foreign location away from the home location, and identify data interactions made at the foreign location that are associated with a foreign possession 166 owned by the primary user 112 at the foreign location. For example, central manager 170 may detect that the primary user 112 has acquired a new home in a foreign country based on detecting one or more data interactions performed by the primary user 112 in the foreign country including, but not limited to, registering the home against the name and/or social security number of the primary user 112, the foreign home declared in filings to an institution and a wire transfer to a realtor, builder or title company in the foreign country. In response to detecting that the primary user 112 has acquired a new foreign possession 166 in a foreign location, central manager 170 may send out a notification to the primary computing node 106 asking the primary user 112 to confirm the new foreign possession 166. Upon receiving confirmation of the new foreign possession 166 from the primary computing node 106 (e.g., provided by primary user 112), central manager 170 may store information relating to the foreign possession 166 in the secondary blockchain 162. For example, central manager 170 may generate a new block 164 of the secondary blockchain 162 that stores information relating to the newly acquired foreign possession 166 and adds the new block 164 to the secondary blockchain 162. In one or more embodiments, the secondary blockchain 162 stores information relating to all foreign possessions 166 owned by the primary user 112 including any updates to the foreign possessions 166 (e.g. acquiring new foreign possessions or abandoning existing foreign possessions) and data interactions performed by the primary user 112 relating to the foreign possessions 166. In one embodiment, the primary user 112 may explicitly declare a foreign possession 166 using the primary computing node 106, for example, by entering details of the foreign possession in respective fields of a user interface or by uploading a document including information relating to the foreign possession 166. Central manager 170 may be configured to obtain the information relating to each foreign possession 166 provided by the primary user 112 and store the information in the secondary blockchain 162.

In one or more additional embodiments, when information relating to a new foreign possession 166 is added to secondary blockchain 160, central manager 170 may be configured to send out a notification to the primary computing node 106 asking the primary user 112 to designate one or more nominee users 114 in relation to the newly added foreign possession 166 and provide information regarding how the newly added foreign possession 166 is to be distributed to the one or more designated nominee users 114. Upon receiving the requested information, central manager 170 may update data files related to the nominee information 154 by adding information relating to the one or more nominee users 114 in relation to the newly added foreign possession 166. In one embodiment, central manager 170 may generate a new nominee block that stores the updated data files related to nominee information 154 and adds the new nominee block to private blockchain 122.

At operation 206, central manager 170 (e.g., implemented by the central computing node 108) determines whether the primary user 112 has died. Central manager 170 may be configured to receive a notification when the primary user 112 dies. For example, central manager 170 may be configured to receive a copy of a death certificate verifying that the primary user 112 has died. Central manager 170 may determine that the primary user 112 has died in response to receiving the notification. When central manager 170 determines that the primary user 112 has not died (e.g., central manager has not received a valid death certificate), method 200 proceeds to operation 208 where central manager continues to update one or more of primary possessions 132, nominee information 134/154, nominee possessions 152 and foreign possessions 166 from time to time as described above. When the central manager 170 determines that the primary user 112 has died, method proceeds to operation 210.

At operation 210 central manager 170 extracts information relating to the first plurality of possessions (e.g., primary possessions 132 and/or foreign possessions 166) and nominee information 134/154 from the private blockchain 122.

As described above, in response to receiving the notification that the primary user 112 has passed away, central manager 170 may be configured to extract information relating to the primary possessions 132 from respective data files stored in the primary block 130 and/or extract updated information relating to the primary possessions 132 stored in one or more other blocks 124 of the private blockchain 122. Central manager 170 may also be configured to extract information relating to foreign possessions 166 from respective data files stored in one or more blocks 164 of the secondary blockchain 162. Central manager 170 may also be configured to extract verified nominee information 154 from respective data files stored in the nominee block 150 and/or updated nominee information 154 from respective data files stored in one or more other blocks 124 of the private blockchain 122. In one embodiment, nominee information 154 may include information relating to how each primary possession 132 is to be distributed to one or more nominee users 114.

In one embodiment, in response to receiving a notification that the primary user 112 has passed away, central manager 170 updates records relating all primary possessions 132 to reflect that the primary user 112 has passed away.

At operation 212, central manager 170 identifies a second plurality of possessions (e.g., nominee possessions 152) owned by one or more nominee users 114. Central manger 170 may be configured to extract information relating to nominee possessions 152 from respective data files stored in the nominee block 150 and/or updated information relating to the nominee possessions 152 stored in one or more other blocks 124 of the private blockchain 122. In one embodiment, central manager 170 may be configured to extract information relating to one or more of the primary possessions 132, nominee information 134, nominee possessions 152 and foreign possessions 166 from a soft copy of a document uploaded by the primary user 112. and stored in the primary blockchain 122.

At operation 214, central manager 170 identifies at least one data point common between each of one or more primary possessions 132 and/or foreign possessions 166 and corresponding nominee possessions 152.

At operation 216, central manager 170 maps one or more primary possessions 132 and/or foreign possessions 166 to the corresponding nominee possessions 152, based on the at least one common data point between the possessions.

As described above, central manager 170 employs the machine learning model 172 to extract a plurality of data points from data relating to primary possessions 132 and foreign possessions 166 stored in source data files (e.g., in primary blockchain 122 and secondary blockchain 160 respectively), and to further extract a plurality of data points from data relating to nominee possessions 152 stored in a plurality of target data files of primary blockchain 122. The machine learning model compares the data points extracted from the source data files with the data points extracted from the target data files. For each source data file containing data relating to a primary possession 132 or a foreign possession 166, machine learning model 172 intelligently selects a target data file that has at least one common data point with the source data file. The central manager 170 transfers data from the source data file to the selected target data file.

For example, machine learning model 172 may be configured to map one or more primary possessions 132 and foreign possessions 166 to data relating to corresponding nominee possessions 152 based on common data points between the primary possessions 132 and nominee possessions 152. Based on the information stored in the private blockchain 122 and the secondary blockchain 160 the machine learning model 172 may segregate the primary possessions 132, foreign possessions 166 and nominee possessions 152 based on the type of each possession. Machine learning model 172 may intelligently extract data points from information relating to the primary possessions 132/foreign possessions 166 and information relating to the nominee possessions 152. Data points relating to each primary possession 132/or foreign possession 166 may include one or more attributes relating to the primary possession 132 or foreign possession 166 such as a type of the primary possession 132/foreign possession, a unique identifier related to the primary possession 132/foreign possession 166 (e.g., data file number), a value of the primary possession 132/foreign possession etc. Similarly data points relating to each nominee possession 152 may include one or more attributes relating to the nominee possession 152 such as a type of the primary possession 132, a unique identifier related to the nominee possession 152 (e.g., data file number), a value of the nominee possession 152 etc. Machine learning model 172 may compare data points relating to the primary possessions 132 and foreign possessions 166 with the data points relating to the nominee possessions 152. Central manager 170 may map a primary possession 132 or foreign possession 166 to a nominee possession 152 when both possessions are associated with at least one common data point. For example, a primary possession 132 and a nominee possession 152 may be of the same type.

At operation 218, central manager 170 transfers one or more primary possessions 132 and/or foreign possessions 166 to the nominee user 114, based on the mapping between the possessions and after receiving the notification that the primary user has passed away.

As described above, once one or more primary possessions 132 and/or foreign possessions 166 have been mapped to corresponding one or more nominee possessions 152, central manager 170 may be configured to transfer data from a source data file relating to a primary possession 132 or a foreign possession 166 to a target data file of the nominee user 114 containing data relating to a nominee possession 152 mapped to the primary possession or foreign possession. based on the mapping. For example, a primary possession 132 may include a first data file and a nominee possession 152 mapped to the primary possession 132 may include a second data file. In this case, a common data point between the first and second data files may include the first and second data files being of the same type. Central manager 170 may transfer data objects from the first data file to the second data file based on the mapping of the data files.

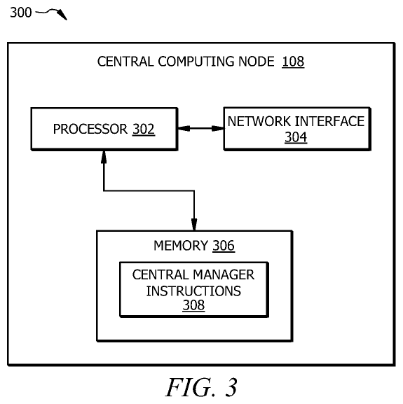

FIG. 3 illustrates an example schematic diagram 300 of a central computing node 108 shown in FIG. 1, in accordance with one or more aspects of the present disclosure. The central computing node 108 as shown in FIG. 3 may be part of the first blockchain network 120 and/or the second blockchain network 160 and may perform at least a portion of the functions performed by the first blockchain network 120 and/or the second blockchain network 160. The central computing node 108 may additionally or alternatively implement the central manager 170.

The central computing node 108 comprises a processor 302, a memory 306, and a network interface 304. The central computing node 108 may be configured as shown in FIG. 3 or in any other suitable configuration.

The processor 302 comprises one or more processors operably coupled to the memory 306. The processor 302 is any electronic circuitry including, but not limited to, state machines, one or more central processing unit (CPU) chips, logic units, cores (e.g. a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions. For example, the one or more processors are configured to execute central manager instructions 308 to implement the central manager 170 described above. In this way, processor 302 may be a special-purpose computer designed to implement the functions disclosed herein.

The memory 306 comprises one or more disks, tape drives, or solid-state drives, and may be used as an over-flow data storage device, to store programs when such programs are selected for execution, and to store instructions and data that are read during program execution. The memory 306 may be volatile or non-volatile and may comprise a read-only memory (ROM), random-access memory (RAM), ternary content-addressable memory (TCAM), dynamic random-access memory (DRAM), and static random-access memory (SRAM).

The memory 306 is operable to store data and instructions used to implement a respective function of the computing node 104. For example, when the central computing node 108 is part of the first blockchain network 120, memory 306 may store a copy of the blockchain 122.

The network interface 304 is configured to enable wired and/or wireless communications. The network interface 304 is configured to communicate data between the computing node 104 and other devices (e.g. other computing nodes 104 of the computing infrastructure 102), systems, or domains. For example, the network interface 304 may comprise a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a central computing node; and
a primary computing node of a primary user communicatively coupled to the central computing node, wherein the central computing node and the primary computing node are part of a blockchain network, the primary computing node comprising a first processor configured to:
receive information relating to a first plurality of possessions owned by the primary user, wherein the information includes information relating to at least one nominee user that is to receive at least a portion of the first plurality of possessions after demise of the primary user; and
record the received information in a first block of a private blockchain implemented by the blockchain network, wherein the primary user owns the private blockchain and can provide one or more access rights to other computing nodes of the blockchain network;
the central computing node comprising a second processor configured to:
receive a notification that the primary user has passed away;
extract the information relating to the first plurality of possessions and the at least one nominee user from the first block of the private blockchain;
identify a second plurality of possessions owned by the at least one nominee user;
identify at least one data point common between each of one or more possessions from the first plurality of possessions and corresponding one or more possessions from the second plurality of possessions;
map each of the one or more possessions from the first plurality of possessions to the corresponding one or more possessions from the second plurality of possessions, based on the at least one common data point; and
transfer the one or more possessions from the first plurality of possessions to the at least one nominee user, based on the mapping and after receiving the notification that the primary user has passed away.

2. The system of claim 1, wherein:
the one or more possessions from the first plurality of possessions includes a first data file of the primary user;
the one or more possessions from the second plurality of possessions includes a second data file of the at least one nominee user;
the at least one common data point includes a common attribute shared by the first data file and the second data file, wherein the common attribute is indicative of a type of a data file; and
the second processor is further configured to:
map the first data file to the second data file based on the common attribute; and
transfer data objects from the first data file to the second data file after receiving a notification that the primary user has passed away.

3. The system of claim 1, wherein the second processor is further configured to:
record information relating to the second plurality of possessions owned by the at least one nominee user in a second block of the private blockchain,
wherein identifying the second plurality of possessions comprises extracting the information relating to the second plurality of possessions from the second block after receiving the notification that the primary user has passed away.

4. The system of claim 1, wherein the second processor is further configured to:
extract a first plurality of data points from the information relating to the at least one nominee user received from the primary computing node of the primary user;
extract a second plurality of data points corresponding to the first plurality of data points from the identified second plurality of possessions owned by the at least one nominee user;
compare each of the first plurality of data points with a corresponding data point from the second plurality of data points;
detect that at least one data point from the first plurality of data points does not match with the corresponding data point from the second plurality of data points;
send an indication of mismatch in the data points to the primary computing node;
receive an updated data point corresponding to the mismatched data points in response to sending the indication; and
store the updated data point in the private blockchain.

5. The system of claim 1, wherein the second processor is further configured to:
detect an interaction performed by the primary user at a foreign location outside a home location, wherein the interaction relates to a foreign possession owned by the primary user at the foreign location;
send a notification to the primary computing node asking whether the foreign possession is to be added to the first plurality of possessions owned by the primary user;
receive instructions to add the foreign possession to the first plurality of possessions owned by the primary user; and
record information relating to the foreign possession in a second block of a secondary blockchain implemented by the blockchain network, wherein the secondary blockchain is communicatively coupled to the private blockchain using cross-chain technology.

6. The system of claim 1, wherein the second processor is further configured to:
in response to receiving the notification that the primary user has passed away, freeze the first block of the private blockchain so that the information relating to the first plurality of possessions cannot be modified.

7. The system of claim 1, wherein:
receiving information relating to the first plurality of possessions owned by the primary user includes receiving a copy of a will document having the information relating to the first plurality of possessions and the nominee user; and
the second processor is further configured to extract information relating to the first plurality of possessions and the nominee user from the will document.

8. A method for transferring possessions, comprising:
receiving information relating to a first plurality of possessions owned by a primary user, wherein the information includes information relating to at least one nominee user that is to receive at least a portion of the first plurality of possessions after demise of the primary user;
recording the received information in a first block of a private blockchain implemented by a blockchain network, wherein the primary user owns the private blockchain and can provide one or more access rights to other computing nodes of the blockchain network;
receiving a notification that the primary user has passed away;
extracting the information relating to the first plurality of possessions and the at least one nominee user from the first block of the private blockchain;
identifying a second plurality of possessions owned by the at least one nominee user;
identifying at least one data point common between each of one or more possessions from the first plurality of possessions and corresponding one or more possessions from the second plurality of possessions;
mapping each of the one or more possessions from the first plurality of possessions to the corresponding one or more possessions from the second plurality of possessions, based on the at least one common data point; and
transferring the one or more possessions from the first plurality of possessions to the at least one nominee user, based on the mapping and after receiving the notification that the primary user has passed away.

9. The method of claim 8, wherein:
the one or more possessions from the first plurality of possessions includes a first data file of the primary user;
the one or more possessions from the second plurality of possessions includes a second data file of the at least one nominee user;
the at least one common data point includes a common attribute shared by the first data file and the second data file, wherein the common attribute is indicative of a type of a data file; and
further comprising:
mapping the first data file to the second data file based on the common attribute; and
transferring data objects from the first data file to the second data file after receiving a notification that the primary user has passed away.

10. The method of claim 8, further comprising:
recording information relating to the second plurality of possessions owned by the at least one nominee user in a second block of the private blockchain,
wherein identifying the second plurality of possessions comprises extracting the information relating to the second plurality of possessions from the second block after receiving the notification that the primary user has passed away.

11. The method of claim 8, wherein further comprising:
extracting a first plurality of data points from the information relating to the at least one nominee user received from the primary computing node of the primary user;
extracting a second plurality of data points corresponding to the first plurality of data points from the identified second plurality of possessions owned by the at least one nominee user;
comparing each of the first plurality of data points with a corresponding data point from the second plurality of data points;
detecting that at least one data point from the first plurality of data points does not match with the corresponding data point from the second plurality of data points;
sending an indication of mismatch in the data points to the primary computing node;
receiving an updated data point corresponding to the mismatched data points in response to sending the indication; and
storing the updated data point in the private blockchain.

12. The method of claim 8, further comprising:
detecting an interaction performed by the primary user at a foreign location outside a home location, wherein the interaction relates to a foreign possession owned by the primary user at the foreign location;
sending a notification to the primary computing node asking whether the foreign possession is to be added to the first plurality of possessions owned by the primary user;
receiving instructions to add the foreign possession to the first plurality of possessions owned by the primary user; and
recording information relating to the foreign possession in a second block of a secondary blockchain implemented by the blockchain network, wherein the secondary blockchain is communicatively coupled to the private blockchain using cross-chain technology.

13. The method of claim 8, further comprising:
in response to receiving the notification that the primary user has passed away, freezing the first block of the private blockchain so that the information relating to the first plurality of possessions cannot be modified.

14. The method of claim 8, wherein:
receiving information relating to the first plurality of possessions owned by the primary user includes receiving a copy of a will document having the information relating to the first plurality of possessions and the nominee user; and
further comprising extracting information relating to the first plurality of possessions and the nominee user from the will document.

15. A computer-readable medium for transferring possessions, wherein the computer-readable medium stores instructions which when executed by a processor perform a method comprising:
receiving information relating to a first plurality of possessions owned by a primary user, wherein the information includes information relating to at least one nominee user that is to receive at least a portion of the first plurality of possessions after demise of the primary user;
recording the received information in a first block of a private blockchain implemented by a blockchain network, wherein the primary user owns the private blockchain and can provide one or more access rights to other computing nodes of the blockchain network;
receiving a notification that the primary user has passed away;
extracting the information relating to the first plurality of possessions and the at least one nominee user from the first block of the private blockchain;
identifying a second plurality of possessions owned by the at least one nominee user;
identifying at least one data point common between each of one or more possessions from the first plurality of possessions and corresponding one or more possessions from the second plurality of possessions;
mapping each of the one or more possessions from the first plurality of possessions to the corresponding one or more possessions from the second plurality of possessions, based on the at least one common data point; and
transferring the one or more possessions from the first plurality of possessions to the at least one nominee user, based on the mapping and after receiving the notification that the primary user has passed away.

16. The computer-readable medium of claim 15, wherein:
the one or more possessions from the first plurality of possessions includes a first data file of the primary user;
the one or more possessions from the second plurality of possessions includes a second data file of the at least one nominee user;
the at least one common data point includes a common attribute shared by the first data file and the second data file, wherein the common attribute is indicative of a type of a data file; and
further comprising instructions for:
mapping the first data file to the second data file based on the common attribute; and
transferring data objects from the first data file to the second data file after receiving a notification that the primary user has passed away.

17. The computer-readable medium of claim 15, further comprising instruction for:
recording information relating to the second plurality of possessions owned by the at least one nominee user in a second block of the private blockchain,
wherein identifying the second plurality of possessions comprises extracting the information relating to the second plurality of possessions from the second block after receiving the notification that the primary user has passed away.

18. The computer-readable medium of claim 15, wherein further comprising instructions for:
extracting a first plurality of data points from the information relating to the at least one nominee user received from the primary computing node of the primary user;
extracting a second plurality of data points corresponding to the first plurality of data points from the identified second plurality of possessions owned by the at least one nominee user;
comparing each of the first plurality of data points with a corresponding data point from the second plurality of data points;
detecting that at least one data point from the first plurality of data points does not match with the corresponding data point from the second plurality of data points;
sending an indication of mismatch in the data points to the primary computing node;
receiving an updated data point corresponding to the mismatched data points in response to sending the indication; and
storing the updated data point in the private blockchain.

19. The computer-readable medium of claim 15, further comprising instructions for:
detecting an interaction performed by the primary user at a foreign location outside a home location, wherein the interaction relates to a foreign possession owned by the primary user at the foreign location;
sending a notification to the primary computing node asking whether the foreign possession is to be added to the first plurality of possessions owned by the primary user;
receiving instructions to add the foreign possession to the first plurality of possessions owned by the primary user; and
recording information relating to the foreign possession in a second block of a secondary blockchain implemented by the blockchain network, wherein the secondary blockchain is communicatively coupled to the private blockchain using cross-chain technology.

20. The computer-readable medium of claim 15, further comprising instructions for:
in response to receiving the notification that the primary user has passed away, freezing the first block of the private blockchain so that the information relating to the first plurality of possessions cannot be modified.
